(19) United States
(12) Patent Application Publication
(10) Pub. No.: US 2007/0089934 A1
(43) Pub. Date: Apr. 26, 2007

(54) Lifting mast for a lift truck

(75) Inventors: Jessica Finke, Hamburg (DE); Paul Rickers, Norderstedt (DE); Henrik Schroder, Winsen-Roydorf (DE)

Correspondence Address: VIDAS, ARRETT & STEINKRAUS, P.A., 6109 BLUE CIRCLE DRIVE, SUITE 2000, MINNETONKA, MN, 55343-9185, US

(73) Assignee: Jungheinrich Aktiengesellschaft, Hamburg (DE)

(21) Appl. No.: 11/583,957

(22) Filed: Oct. 19, 2006

(30) Foreign Application Priority Data
Oct. 22, 2005 (DE) 10 2005 050 733.6

(51) Int. Cl. B66F 9/06

(52) U.S. Cl. 187/227

(57) ABSTRACT

A lifting mast, in particular for a high-bay stacker lift truck, having a fixed mast and at least one extendable mast section with two parallel lift drives arranged laterally on the mast for extending the mast section from the fixed mast and a control for the lift drives, wherein a regulating device is provided for the two lift drives for measuring a path difference in the lifting paths of the lift drives and the lift drives are controlled such that the path difference remains zero.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Height-adjustable masts are known in a great variety of constructional forms as e.g. components of industrial trucks having hoisting mechanisms. The use of such masts allows for the loads to be transported to be grasped and deposited at different heights, whereby the lifted load is moved substantially vertically.

A mast of this type consists in principle of an outer fixed frame within which load lifting means move directly. This type of construction is relatively rare. In most cases, one or more extendable masts move within the fixed mast. In single or two-stage telescoping masts, this refers to an inner extendable mast. In the case of a three-stage telescoping mast, there are two, and in four-stage telescoping masts, there are three inner extendable masts.

The individual mast frames consist of two lateral support profiles which are connected atop and below by cross struts. The bending moment resulting from the mast load is normally transmitted between the internesting mast frames by means of idle pulleys disposed at the upper and lower ends of the frame profile. The drive for the vertical adjustment is usually provided by hydraulic lift cylinders and chains producing a relative motion between the individual mast frames.

The construction of mast frames is such that an extended mast is flexurally rigid in its main direction of loading so that its bending moment deformation from a load at higher height is as low as possible. Too large of a deformation leads to a shifting of the load center and thus to an increase in the tilting moment acting on the truck. This has a negative impact on the vehicle's stability. The necessary flexural strength is attained by selecting mast frame profiles with appropriately large area moments of inertia.

In addition to the main bend load, lateral bending caused by an eccentric center of gravity to the mast load or by dynamic lateral forces of mass can also occur. Due to the resultant lateral bending of the mast, the lever arm live load is increased and thus the lateral tilting moment is also increased. The rigidity of mast frames relative to lateral bending is usually attained by connecting the two lateral support profiles of the mast frame with massive (ladder-type) cross struts. Such cross struts obstruct the view through the mast frame and increase its weight.

DE 4 038 730, the entire contents of which is hereby incorporated by reference in its entirety, discloses a device which compensates displacement of the load center resulting from mast deformation due to the load moment by inclining the mast. Lateral bending is not influenced.

DE 101 33 585, the entire contents of which is hereby incorporated by reference in its entirety, A1 describes a device for compensating bending in the main direction of bending.

DE 3 016 156 and DE 3 101 953, the entire contents of which is hereby incorporated by reference in its entirety, describe masts in which longitudinal and lateral deformations are compensated by traction means exerting counter moments on the masts. For this purpose, the masts must be equipped with complex auxiliary mechanisms.

DE 103 49 123 A1, the entire contents of which is hereby incorporated by reference in its entirety, discloses a lift unit in which two laterally-arranged lift cylinders of a conventional lifting mast can be charged with different hydraulic pressure or the pressure be can changed dynamically by means of an additional pump between the cylinders.

Monitoring the inclination of a mast with a position sensor and controlling the pressure in the hydraulic cylinders so as to compensate inclination is known from EP 1 528 035 A2, the entire contents of which is hereby incorporated by reference in its entirety. DD 30489, the entire contents of which is hereby incorporated by reference in its entirety, discloses load-dependent controlling of the quantity of flow media to the lift cylinders of a lifting mast.

The object on which the invention is based is that of providing a lifting mast, in particular for a high-bay stacker lift truck, which a priori prevents lateral bending.

### BRIEF SUMMARY OF THE INVENTION

The lifting mast according to the invention provides a regulating device for the two lift drives for measuring a path difference in the lifting paths of the lift drives and controlling the lift drives such that the path difference remains zero.

The lift drives can comprise two motors, each acting on a mast support by means of a spindle drive. A path difference can be determined by measuring the spindle drive angle of rotation. A path difference—as indicated above—is compensated. Alternatively, two hydraulic drives, i.e. hydraulic cylinders, connectable to a hydraulic source are provided. To achieve in each case the same path on each side of the mast, the supply of displaced volume to the hydraulic cylinders is controlled. It is thereby to be ensured that the hydraulic cylinders are supplied the same volume of pressurizing medium, resulting in the correspondingly same lifting paths.

Instead of the lifting path of the hydraulic cylinders, the control variable for the volume of pressurizing medium supplied to the hydraulic cylinders can also be the lateral inclination of the mast frame.

Alternatively to a regulating device ensuring the same supply volume of pressurizing medium, a further solution to the object according to the invention provides for arranging a flow divider between the source of hydraulic pressure and the hydraulic cylinders, via which each of the hydraulic cylinders are supplied with the same volume of pressurizing medium. In practice, hydraulic flow dividers do not work ideally such that the same lifting path for the hydraulic cylinders cannot be ensured in a wholly reliable fashion. This is due to the pressurizing medium being compressible to a certain extent and there being resilience of the components conducting the pressurizing medium in the line system, for example pipes and hoses. For practical applications, flow dividers of this type can work to satisfaction.

An alternative design solution for the invention provides for a double-acting hydraulic cylinder and its annular chamber being connected to the base of the other hydraulic cylinder, wherein the effective cross-section of the annular chamber is equal to the cross-section of the piston chamber of the other hydraulic cylinder. This type of hydraulic circuit allows the same lifting path to be exacted on the two hydraulic cylinders.

Another design of the invention provides for the hydraulic cylinder lines to be connected on the outflow side of the flow divider via a pump regulated in its rotational speed and the pump to be driven by a motor given a path difference of the hydraulic cylinders or an angle of inclination of the lifting mast, wherein the rotational direction of the motor is a prognostic function of the path difference, the angle of inclination respectively. The rotational speed and the conveying direction of the pump are predefined by an electronic control which uses a sensor to measure the path of each lift cylinder or mast angle of inclination. According to one design of the invention, a restrictor can also be connected in parallel to the compensating pump to ensure that the pump is not operated at inadmissibly low rotational speeds.

According to a further design of the invention, a shut-off valve can be provided in series with the compensating pump which only opens when the compensating pump is in operation. This valve is closed when the compensating pump fails so as to avoid equalization of pressure and thus a loss of the stabilizing effect. In the case of a path difference, respectively an angle of inclination of the lifting mast, the compensating pump is then controlled such that the path difference or the angle of inclination is minimized. This type of arrangement also enables dynamic deforma-tions, such as those which occur e.g. when industrial trucks corner, to be reduced to a certain extent.

Parallel to the flow divider, a further design of the invention provides for a controllable triple/three-way valve with two input connections on the main cylinder, while an output connection is connected to the tank. The regulating device controls the valve based on the path difference or angle of inclination such that one of the two hydraulic cylinders is connected to the tank. Any possible difference in the lifting path of the hydraulic cylinders is then compensated by allowing fluid into the tank through the valve until the lifting path of the two cylinders is again equal.

Another design of the invention finally provides for each lift cylinder being assigned a controllable lifting/lowering valve disposed at the outlet of a hydraulic pump and the regulating device controlling one of the two lifting/lowering valves based on the path difference or angle of inclination such that the path difference or angle of inclination will in each case be zero.

### BRIEF DESCRIPTION OF THE SEVERAL VIEWS OF THE DRAWINGS

The following will make reference to the drawings in describing the invention in greater detail:

FIG. 1 shows a lifting mast as can be equipped with a device according to the invention.

FIG. 2 shows a first embodiment according to the invention.

FIG. 3 shows a second embodiment according to the invention.

FIG. 4 shows a third embodiment according to the invention.

FIG. 5 shows a fourth embodiment according to the invention.

FIG. 6 shows a fifth embodiment according to the invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

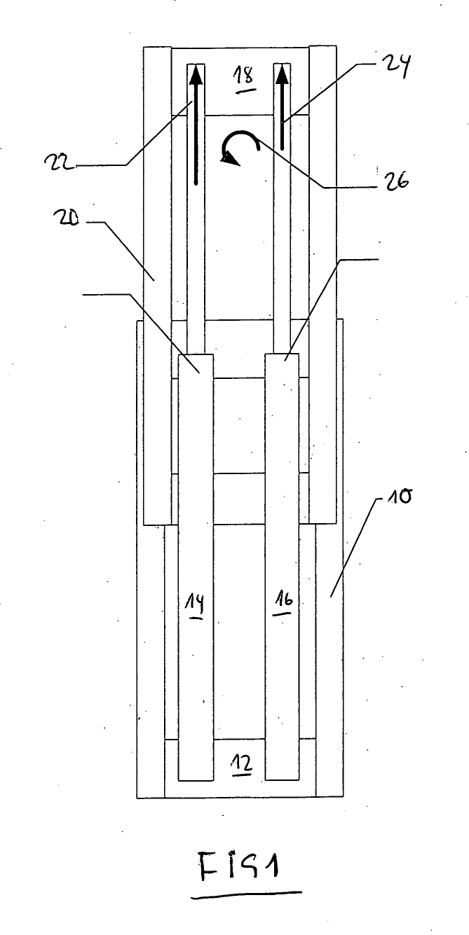

FIG. 1 shows a schematic view of a lifting mast having a fixed mast frame 10, which can be attached to e.g. a high-bay stacker. Two hydraulic cylinders 14, 16 are supported on a lower cross strut 12 of the fixed mast frame, connected to an upper cross strut 18 of an extendable mast frame 20. Arrows 22 and 24 indicate different lifting forces which lead to a lateral bending moment 26. In the embodiments to be described in the following, bending is to be prevented despite a bending moment generated by the load.

It can be seen from FIG. 2 that the hydraulic cylinders 14, 16 are supplied with pressurizing medium by means of a so-called flow or volume divider 30. The flow divider ensures that both hydraulic cylinders 14, 16 are supplied the same volume of pressurizing medium independently of their load so that the hydraulic cylinders 14, 16 realize the same lifting path.

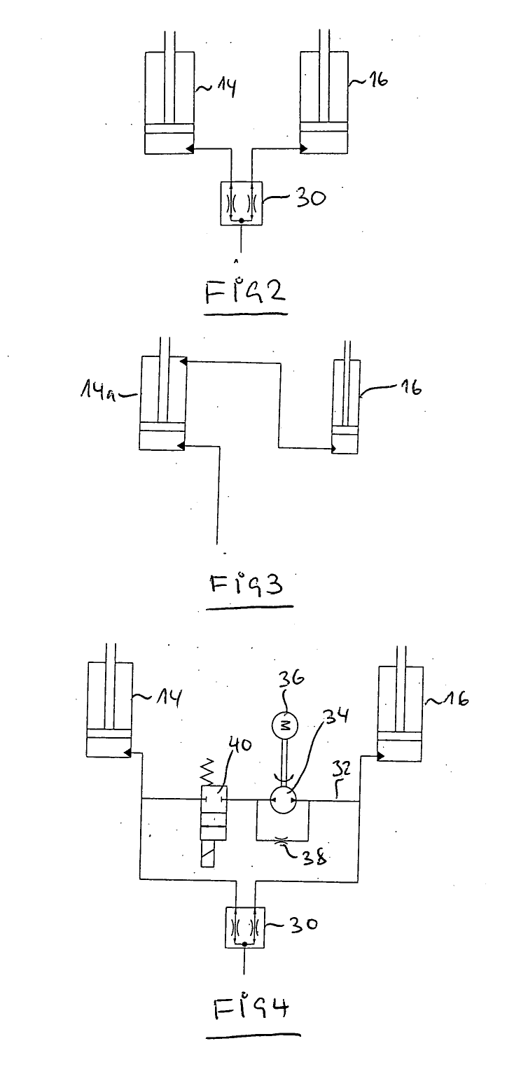

Instead of the single-acting cylinder 14 according to FIGS. 1 or 2, a double-acting hydraulic cylinder 14a is provided in FIG. 3, its annular chamber connected to the piston base of the hydraulic cylinder 16. The hydraulic pump is connected to the piston base of the hydraulic cylinder 14a. This coupling also ensures that adjustment of the extendable mast frame will ensue with the same lifting path on both sides.

In FIG. 4, the hydraulic cylinders 14, 16 are connected through a flow divider 30 to a hydraulic pump. A parallel connection 32 is additionally provided between the supply lines to the hydraulic cylinders 14, 16 in which a small controllable pump 34 driven by an electric motor 36 is arranged. A restrictor 38 is disposed parallel to the pump 34. In addition, a control valve 40 is disposed in the cross-connection. The shown circuit arrangement functions as follows.

The flow divider 30 should actually ensure that the same volume is supplied to each of the hydraulic cylinders 14, 16. For various reasons, however, this is not always guaranteed. A sensor device which is not shown measures the lifting paths of the hydraulic cylinders 14, 16. Upon there being a difference in the measured lifting paths, the electric motor 36 is actuated and drives the pump 34 in such a manner that the measured path difference becomes zero. As soon as the path difference is zero, the motor 36 is switched off. The valve 40, which is otherwise closed when the pump 34 is not in operation, is opened during this procedure so as to not compromise the constant supply of hydraulic cylinders 14, 16 through the flow divider 30 upon a failure of pump 34. The restrictor 38 ensures that the pump is not operated at an inadmissibly low rotational speed.

Instead of measuring the path difference of the lifting paths of the hydraulic cylinders 14, 16, the angle of inclination can also be measured which, using the method described, can again be minimized or brought to zero in the case of unequal value.

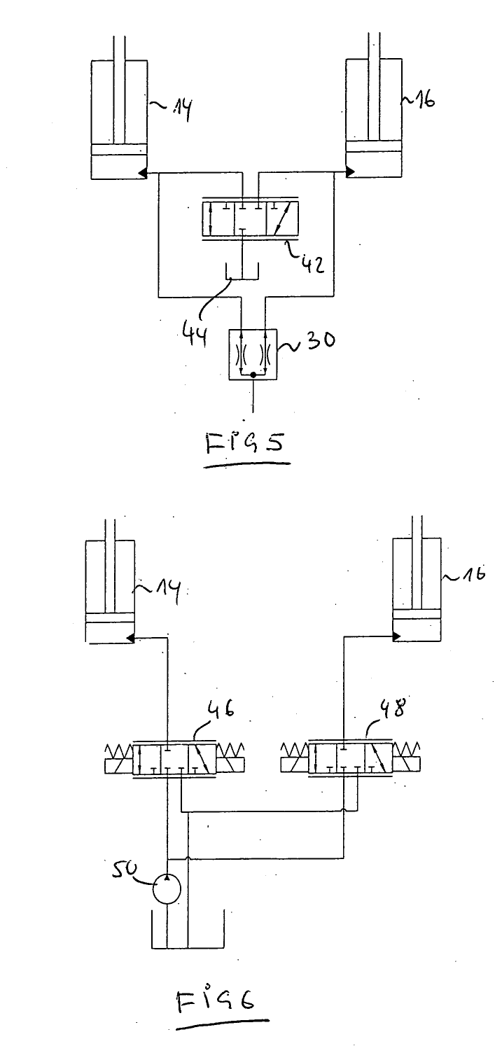

In the embodiment according to FIG. 5, an error of the flow divider 30 can be compensated using a triple/three-way valve 42, the two inlets of which are each connected to the hydraulic cylinders 14, 16 and the outlet of which is connected to a tank 44. Upon a lifting path difference, the valve 42 opens so that pressurizing medium is released into the tank 44 from one of the two hydraulic cylinders 14, 16 until the lifting path of the two cylinders is again the same. The control necessary for this purpose corresponds to that according to FIG. 4.

In the embodiment according to FIG. 6, each hydraulic cylinder 14, 16 is assigned a lifting and lowering valve 46, 48 which are controlled by electronics which are not shown. Sensors which are not shown are used to measure the lifting paths of the hydraulic cylinders 14, 16. The actuation of the valves 46, 48 by the regulating device is such that the supply of pressurizing medium by a pump 50 differs until the lifting path difference is again at zero.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A lifting mast, in particular for a high-bay stacker lift truck, having a fixed mast and at least one extendable mast section with two parallel lift drives arranged laterally on the mast for extending the mast section from the fixed mast and a control for the lift drives, characterized in that a regulating device is provided for the two lift drives for measuring a path difference in the lifting paths of the lift drives and the lift drives are controlled such that the path difference remains zero.

2. The lifting mast according to claim 1, characterized in that the lift drives have two motors, each driving a spindle drive, and the path difference is determined by measuring the angle of rotation of the spindle drives.

3. The lifting mast according to claim 1, characterized in that the lift drives are disposed on hydraulic cylinders (14, 16) connectable to a hydraulic source and the supply of displaced volume to the hydraulic cylinders (14, 16) is controlled such that the lifting paths of the hydraulic cylinders (14, 16) are equal.

4. A lifting mast, in particular for a high-bay stacker lift truck, having a fixed mast and at least one extendable mast section with two parallel hydraulic cylinders arranged laterally for extending the mast section from the fixed mast and a control for the hydraulic cylinders, characterized in that a volume or flow divider (30) is disposed between the hydraulic pressure sources and the hydraulic cylinders (14, 16), by means of which the hydraulic cylinders (14, 16) are supplied with the same volume of pressurizing medium.

5. A lifting mast, in particular for a high-bay stacker lift truck, having a fixed mast and at least one extendable mast section with two parallel hydraulic cylinders arranged laterally for extending the mast section from the fixed mast and a control for the hydraulic cylinders, characterized in that one hydraulic cylinder (14a) is double-acting and its annular chamber connected to the base of the other hydraulic cylinder (16), wherein the effective cross-section of the annular chamber is equal to the cross-section of the piston base of the hydraulic cylinder (16).

6. The lifting mast according to claim 3, characterized in that the lines to the hydraulic cylinders (14, 16) are connected on the outflow side of a volume or flow divider (30) via a pump (34) regulated in its rotational speed and the pump (34) is driven by a motor (36) upon a path difference of the hydraulic cylinders (14, 16) or an angle of inclination of the lifting mast, wherein the rotational direction of the motor (36) is a prognostic function of the path difference, the angle of inclination respectively.

7. The lifting mast according to claim 6, characterized in that a restrictor (38) is connected in parallel to the pump (34).

8. The lifting mast according to claim 6, characterized in that a control valve (40) is disposed in the connecting line between the lines, which is normally closed, although opened when pump (34) is in operation.

9. The lifting mast according to claim 3, characterized in that a controllable triple/three-way valve with two input connections to the hydraulic cylinders (14, 16) is disposed parallel to the volume or flow divider (30), while an output connection connects to the tank (44) and the regulating device controls the valve (42) based on the path difference or angle of inclination such that one of the two hydraulic cylinders (14, 16) is connected to the tank (44).

10. The lifting mast according to claim 3, characterized in that each hydraulic cylinder (14, 16) is assigned a controllable lifting/lowering valve (46, 48) disposed at the outlet of a hydraulic pump (50) and the regulating device controls one of the two lifting/lowering valves (46, 48) based on the path difference such that the path difference will be zero.
